(19) United States
(12) Patent Application Publication
(10) Pub. No.: US 2017/0253791 A1
(43) Pub. Date: Sep. 7, 2017

(54) IMPROVED PERFORMANCE OF CROSSLINKED FRACTURING FLUIDS COMPRISING A NONIONIC SURFACTANT

(71) Applicant: BAKER HUGHES INCORPORATED, HOUSTON, TX (US)

(72) Inventors: MARSHALL G. AULT, SPRING, TX (US); MINH Q. VO, HOUSTON, TX (US); SUSAN A. NGUYEN, HOUSTON, TX (US)

(73) Assignee: BAKER HUGHES INCORPORATED, HOUSTON, TX (US)

(21) Appl. No.: 15/517,411

(22) PCT Filed: Oct. 7, 2015
(86) PCT No.: PCT/US2015/054476

§ 371 Date: Apr. 6, 2017

Related U.S. Application Data
(60) Provisional application No. 62/060,826, filed on Oct. 7, 2014.

(51) Int. Cl. C09K 8/68; C09K 8/60; E21B 43/26; C09K 8/88

(52) U.S. Cl. CPC C09K 8/685; C09K 8/887; C09K 8/602; C09K 8/68; E21B 43/26; E21B 41/02

(57) ABSTRACT

A gel composition for use in subterranean formations is disclosed. The composition can comprise a base fluid, a cross-linkable polymer that is soluble in the base fluid, a nonionic surfactant and a cross-linking agent. The gel composition has improved crosslinked stability. The gel composition can be injected into the subterranean formation as a fracturing fluid and allowed to penetrate the formation. Preferably, the gel composition effectively blocks the water-bearing regions while the oil or gas producing regions are left unblocked so that the oil or gas can be recovered.

### CROSS REFERENCE TO RELATED APPLICATIONS

This patent application claims the benefit, and priority benefit, of U.S. Provisional Patent Application Ser. No. 62/060,826, filed Oct. 7, 2014, the contents of which are incorporated by reference herein in its entirety.

### FIELD OF THE INVENTION

The presently disclosed subject matter relates to a gel composition containing a nonionic surfactant and use of the gel composition in oilfield applications.

### SUMMARY

According to the illustrative embodiments disclosed herein, a gel composition for use in a subterranean formation is provided. The gel composition can include a base fluid, a cross-linkable polymer soluble in the base fluid, a cross-linking agent and a nonionic surfactant. In certain illustrative embodiments, the base fluid can be a brine solution.

### BRIEF DESCRIPTION OF THE DRAWINGS

FIG. 1 is a graph showing viscosity vs. time for 4.8 grams/liter CMHPG at 250 degrees F., tap water with 12% KCl salt, a gel stabilizer with a pH of 6 and a zirconium crosslinker in certain illustrative embodiments.

FIG. 2 is a graph showing viscosity vs. time for 4.8 grams/liter CMHPG at 250 degrees F., tap water with 6% KCl salt, a gel stabilizer with a pH of 6 and a zirconium crosslinker in certain illustrative embodiments.

FIG. 3 is a graph showing viscosity vs. time for 4.8 grams/liter CMHPG at 250 degrees F., tap water with 2% KCl salt, a gel stabilizer with a pH of 6 and a zirconium crosslinker in certain illustrative embodiments.

FIG. 4 is a graph showing viscosity vs. time for 4.8 grams/liter CMHPG at 250 degrees F., 9 ppg brine, a gel stabilizer with a pH of 6 and a zirconium crosslinker in certain illustrative embodiments.

FIG. 5 is a graph showing viscosity vs. time for 4.8 grams/liter CMHPG at 250 degrees F., tap water with 9 ppg mixed brine, a gel stabilizer with a pH of 6 and a zirconium crosslinker in certain illustrative embodiments.

FIG. 6 is a graph showing viscosity vs. time for 3.6 grams/liter CMHPG at 240 degrees F., filtered produced water with a pH of 6 and a zirconium crosslinker in certain illustrative embodiments.

While certain preferred illustrative embodiments will be described herein, it will be understood that this description is not intended to limit the subject matter to those embodiments. On the contrary, it is intended to cover all alternatives, modifications, and equivalents, as may be included within the spirit and scope of the subject matter as defined by the appended claims.

### DETAILED DESCRIPTION

Disclosed herein is a gel composition for use in subterranean formations. In certain illustrative embodiments, the gel composition can comprise a base fluid, a cross-linkable polymer that is soluble in the base fluid, a nonionic surfactant and a cross-linking agent. In certain illustrative embodiments, the gel composition has improved crosslinked stability. The gel composition can be injected into the subterranean formation as a fracturing fluid and allowed to penetrate the formation. The fracturing fluid can transport a proppant into the fracture to keep the frature open to produce oil and gas. The gel composition provides improved performance for crosslinked fracturing fluids in produced waters.

In certain illustrative embodiments, the base fluid can be a brine solution. The brine solution can comprise, for example, a solution of salt (such as sodium chloride) in water. Other examples of materials that can be present in the brine solution can include mono and divalent salts that include potassium chloride, sodium bromide, a sodium bromide/calcium chloride mixture, or a produced brine such as produced water. In general, the brine solution can be any solution that contains salts. In certain illustrative embodiments, the nonionic surfactant has been shown to improve the stability of the crosslinked fluids at temperatures greater than 200° F. when mixed with base fluids composed of the above described brines.

In certain illustrative embodiments, the cross-linkable polymer can be a hydrophilic polymer that is generally soluble in the base fluid and is capable of being cross-linked in solution so that the polymer interconnects to form a semi-solid gel. Examples of these polymers are well known to those skilled in the art. Examples of cross-linkable polymers that can be utilized according to the presently disclosed subject matter can include, for example, guar gum and guar derivatives. Other suitable cross-linkable polymers may also be used in forming the gel composition of the presently disclosed subject matter, and are well known and will be readily apparent to those skilled in the art.

Various cross-linking agents are also well known to those skilled in the art. Examples of suitable cross-linking agents according to the presently disclosed subject matter can include, for example transition metal crosslinkers. These cross-linking agents bond ionically with the polymers to form the cross-linked molecule. Other suitable cross-linking agents may be used in forming the gel composition of the presently disclosed subject matter, and are well known and will be readily apparent to those skilled in the art. The amount of cross-linking agent that is used will typically vary depending upon the type of polymer and the degree of cross-linking desired.

The gel composition of the presently disclosed subject matter can further comprise a nonionic surfactant. Examples of nonionic surfactants that may be used according to the presently disclosed subject matter include Plurafac® versions SLF 45, SLF 18B45, SLF 180, RA 300, LF 400 and/or LF 900, and Dehypon LS 36 which are commercially available from BASF Corporation of Mount Olive, N.J., and Antarox® version BL 759, which is commercially available from Novecare Solvay. In certain illustrative embodiments, the use of non-ionic alcohol ethylene oxide/propylene oxide (“EO/PO”) surfactants such as those described above provides improved viscosity at temperature for the crosslinked fluids.

The nonionic surfactant should be present in the gel composition in an amount sufficient to provide the desired properties. For example, in certain illustrative embodiments, the nonionic surfactant is present in the gel composition of the presently disclosed subject matter in an amount in the range from about 0.0170% to about 0.1013% by weight.

In certain illustrative embodiments, a non-ionic alcohol surfactant can be utilized having a hydrocarbon chain in the range from C₁₀ to C₁₆ and in the range from 5-80 moles of EO (ethoxylation) and in the range from 3-60 moles of PO (propoxylation). Preferably, the EO/PO ratio of the surfactant can be in the range from 1:2 to 4:2. Further, in certain illustrative embodiments the hydrophilic-lipophilic balance (or “HLB”) of the surfactant can be in the range from 11 to 14 and the surfactant is water soluble.

In certain illustrative embodiments, the gel composition of the presently disclosed subject matter can be a metallic crosslinked fracturing fluid. For example, the metallic component of the gel composition can be a transition metal.

Without wishing to be bound by theory, it is believed that the nonionic surfactant such as those described above inhibits the interaction between the metal cations of the brine and the cross-linkable polymer that normally cause the transition metal crosslinked fluids to lose stability.

Other additives suitable for use in operations in subterranean formations also may be added to the gel composition. These other additives can include, but are not limited to, proppants, biocide, scale inhibitor, corrosion inhibitor, paraffin inhibitor, asphaletene inhibitor, iron control and other commonly used oilfield chemicals and combinations thereof. A person having ordinary skill in the art, with the benefit of this disclosure, will know the type and amount of additive useful for a particular application and desired result.

Various methods of treating subterranean formations using a gel composition containing a nonionic surfactant are also disclosed herein. For example, disclosed herein is a method of treating an opening in a subterranean formation. A gel composition is provided comprising a base fluid, a cross-linkable polymer that is soluble in the base fluid, and a cross-linking agent. A nonionic surfactant can be added to the gel composition. In certain illustrative embodiments, the nonionic surfactant can include Plurafac® versions SLF 45, SLF 18B45, SLF 180, RA 300, LF 400 and/or LF 900, and Dehypon LS 36 which are commercially available from BASF Corporation of Mount Olive, N.J., and Antarox® version BL 759, which is commercially available from Novecare Solvay. In certain illustrative embodiments, the gel composition can include a non-ionic alcohol surfactant having a hydrocarbon chain in the range from C₁₀ to C₁₆ and in the range from 5-80 moles of EO (ethoxylation) and in the range from 3-60 moles of PO (propoxylation). Preferably, the EO/PO ratio of the surfactant can be in the range from 1:2 to 4:2. Further, the hydrophilic-lipophilic balance (or “HLB”) of the surfactant can be in the range from 11 to 14 and the surfactant is water soluble. The gel composition can be injected into the opening in the subterranean formation and cross-linked to increase the size of the opening. For example, the cross linked gel composition can cause more width to occur in the opening. It is believed that the nonionic surfactant does not interfere with the cross-linking process and can provide adequate properties without adversely affecting the ability of the gel composition to be injected into the opening.

In certain illustrative embodiments, the gel composition described herein provides a stable crosslinked fluid for use as a high density completions fluid for offshore stimulations. The gel composition described herein can be stable at high temperatures, such as 275° F. or above, with produced waters with high total dissolved solids (“TDS”) without the need for dilution or expensive water treatments.

To facilitate a better understanding of the presently disclosed subject matter, the following examples of certain aspects of certain embodiments are given. In no way should the following examples be read to limit, or define, the scope of the presently disclosed subject matter.

### EXAMPLE 1

The polymer was added to the brine solution and allowed to hydrate for 30 minutes, using a standard Servodyne mixer with a high efficiency paddle at approximately 1000 rpm. Once the fluid was completely hydrated the fluid was buffered to the appropriate pH, crosslinker added, and then loaded into a Chandler 5550 cup. For API testing, the fluid was initially run through a shear rate sweep of 100, 75, 50, and 25 sec⁻¹ to calculate the power law indices n′ and K′ at ambient temperature. After this initial sweep the set temperature ramp initiates and begins to heat up the fluid. The fluid was then sheared at 100 sec⁻¹ for 20 minutes. After 20 minutes of constant shear 100 sec⁻¹, the fluid runs through another shear rate sweep this time at temperature. Again fluid is sheared at 100 sec⁻¹ in between shear rate sweeps and the shear rate sweep repeated every 15 minutes for 2 hours 5 minute then every 30 minutes for the next hour. A RIBS rotor-bob configuration was used.

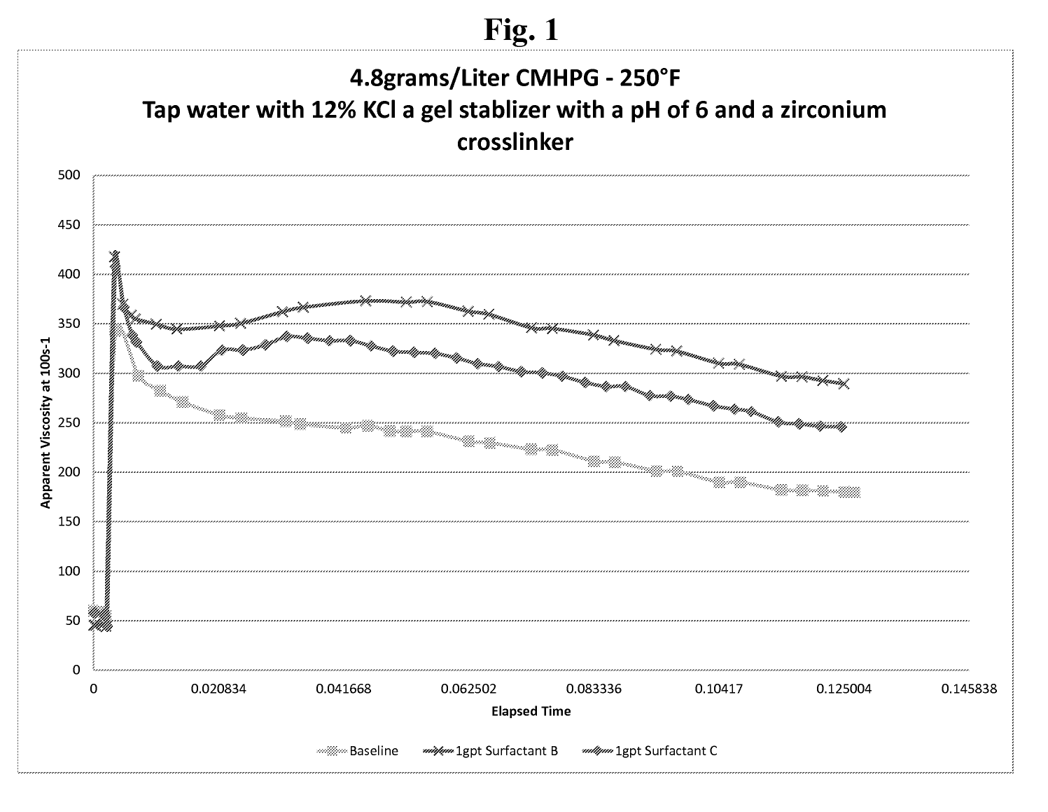

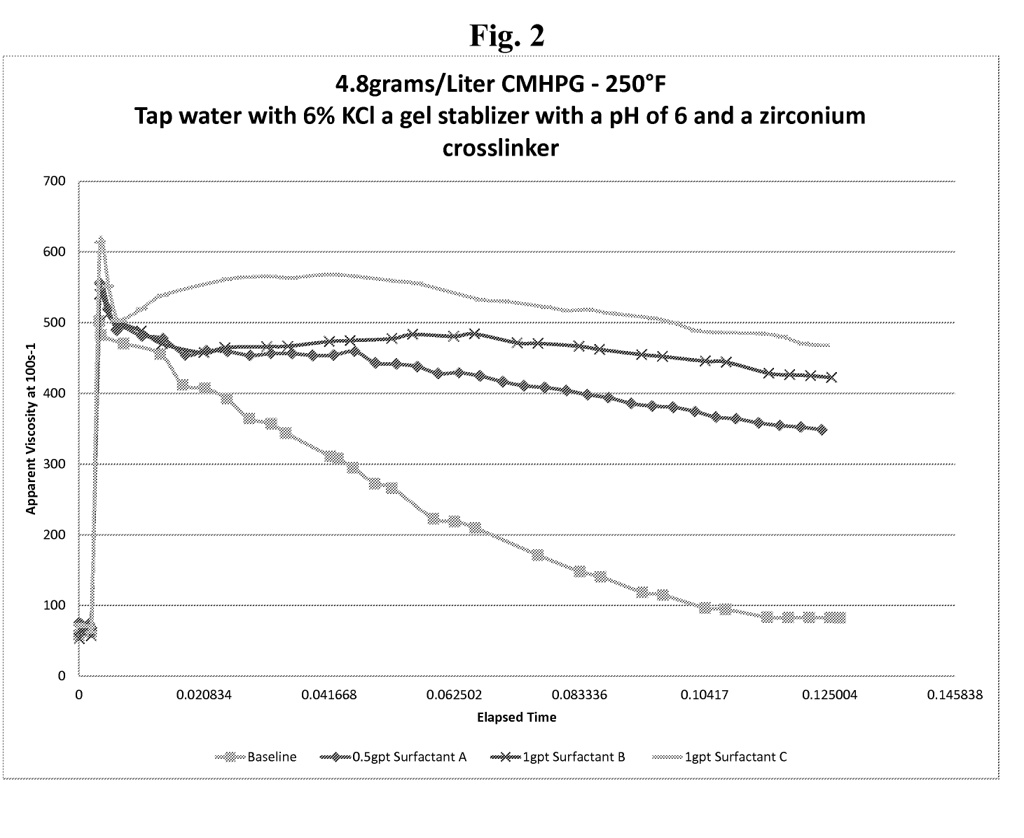

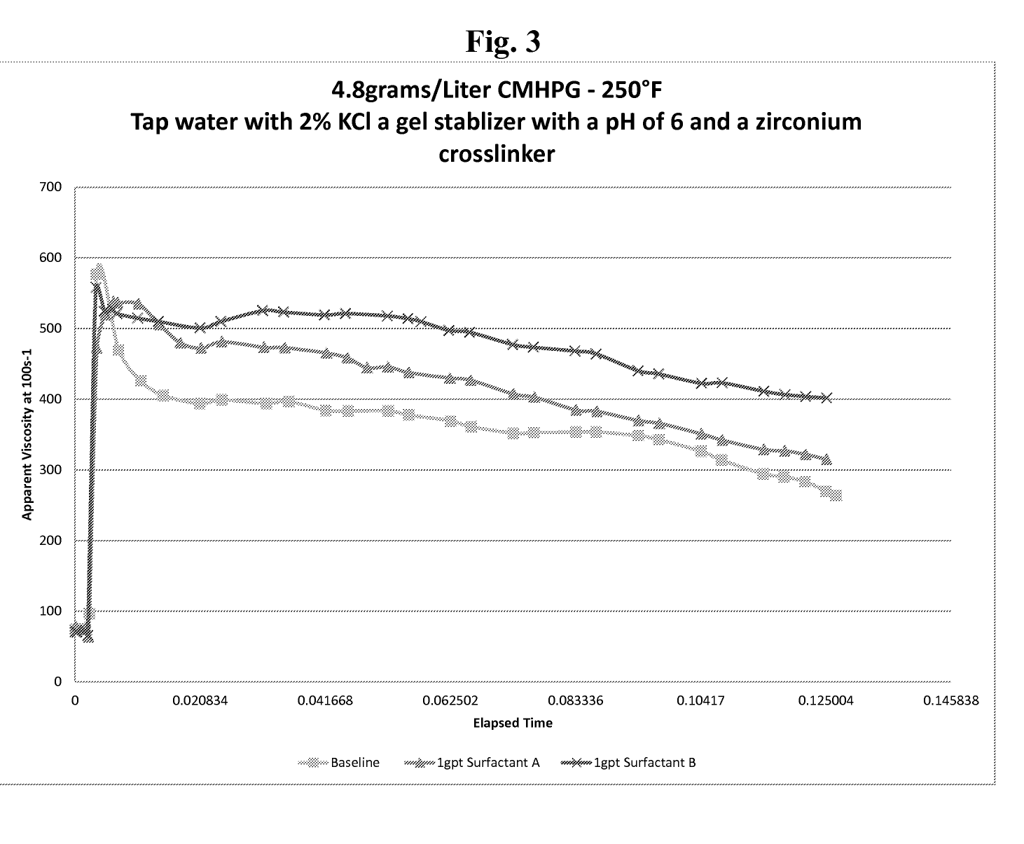

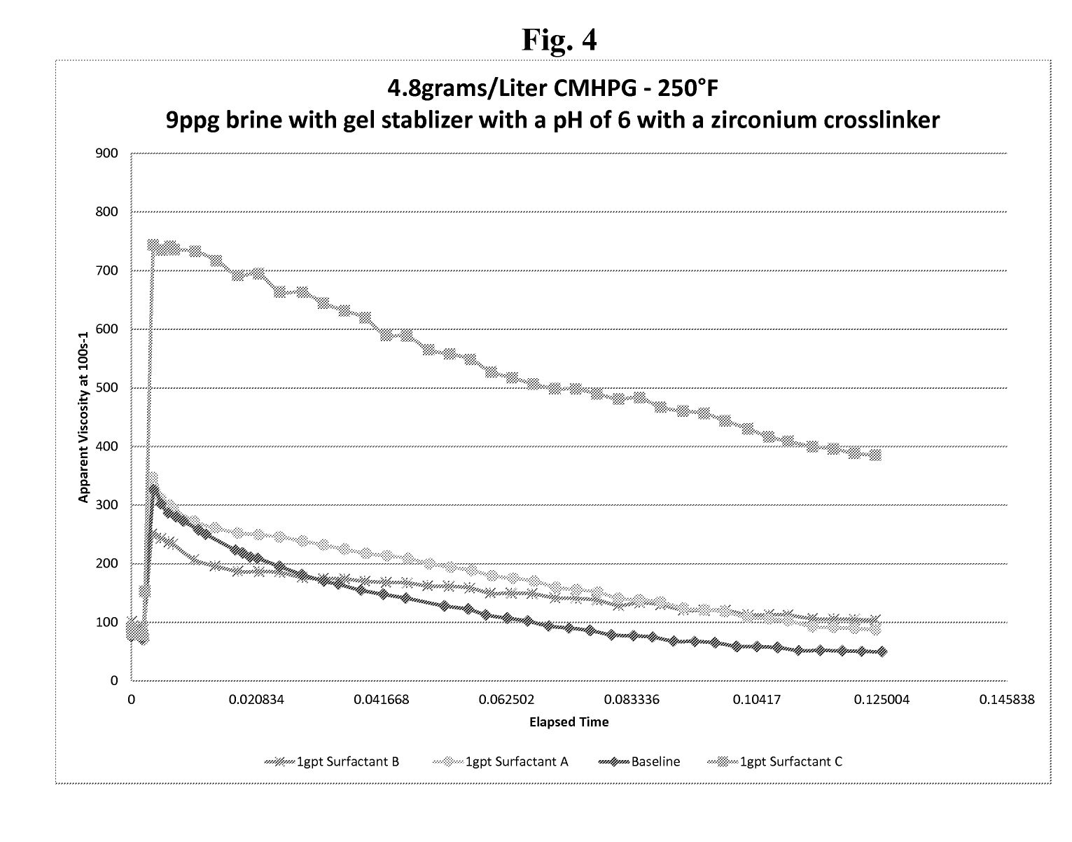

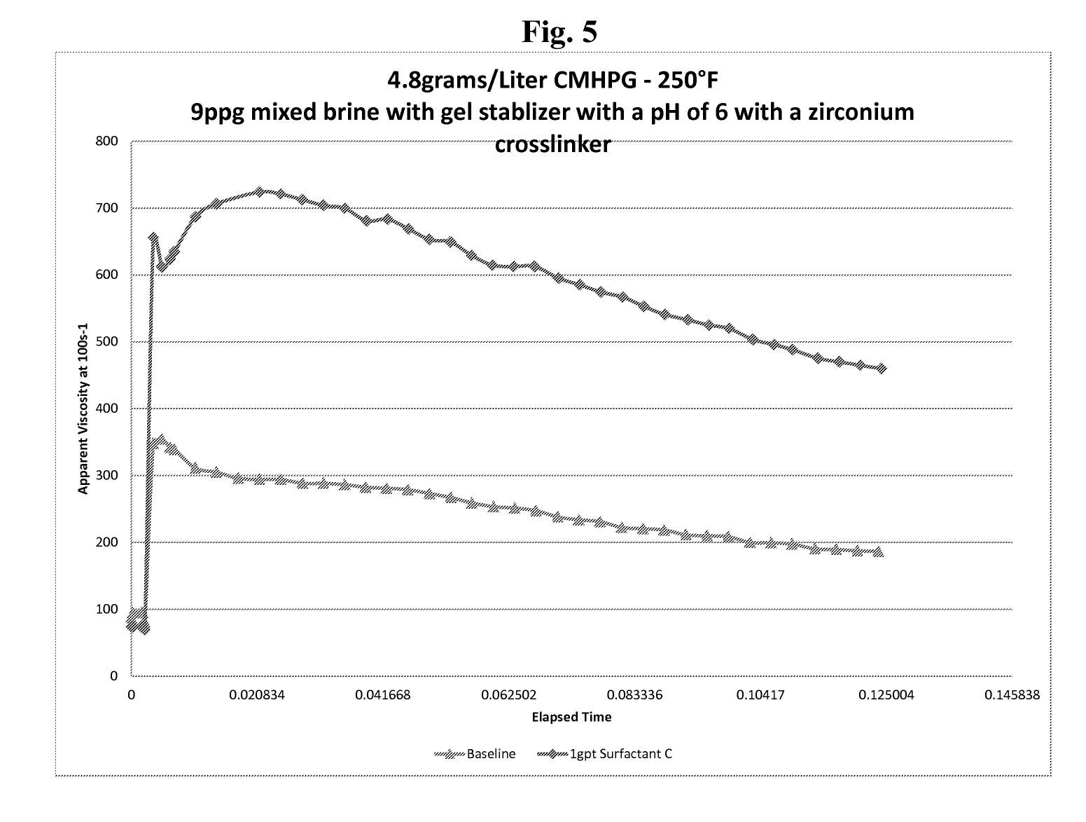

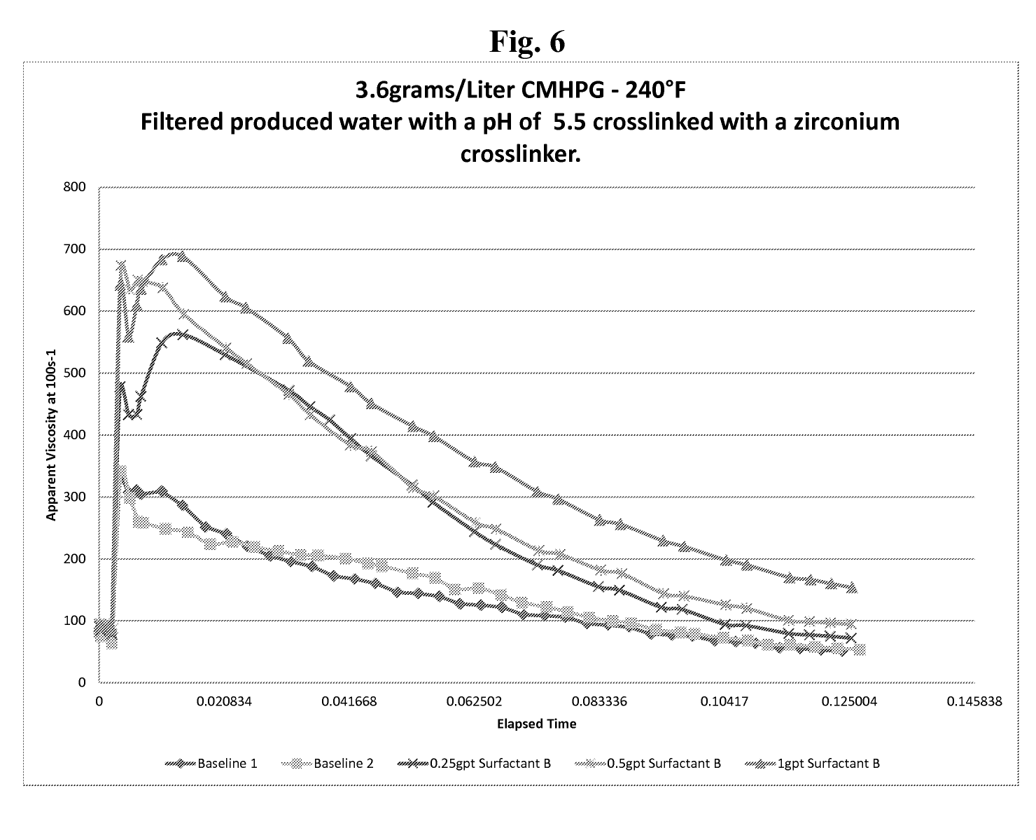

The results of the testing from Example 1 are shown in FIGS. 1-6 hereto, where Surfactant A is Anatrox BL 759, Surfactant B is Plurafac SFL 45, Surfactant C is Plurafac SFL 180, Surfactant D is Plurafac RA 300, Surfactant E is Plurafac LF 400 and Surfactant F is Plurafac LF 900. Shear rate sweep data was removed from all figures for better analysis of the fluid's viscosity. There is improved viscosity performance when utilizing the subject surfactants relative to the baselines for all the figures. Example 1 demonstrates that with the addition of the surfactant, the fluid has more viscosity for a longer period of time.

It is to be understood that any recitation herein of numerical ranges by endpoints includes all numbers subsumed within the recited ranges as well as the endpoints of the range and equivalents.

While the disclosed subject matter has been described in detail in connection with a number of embodiments, it is not limited to such disclosed embodiments. Rather, the disclosed subject matter can be modified to incorporate any number of variations, alterations, substitutions or equivalent arrangements not heretofore described, but which are commensurate with the scope of the disclosed subject matter. Additionally, while various embodiments of the disclosed subject matter have been described, it is to be understood that aspects of the disclosed subject matter may include only some of the described embodiments. Accordingly, the disclosed subject matter is not to be seen as limited by the foregoing description, but is only limited by the scope of the appended claims.

What is claimed is:

1. A gel composition for use in a subterranean formation, the gel composition comprising:
a base fluid comprising a brine solution;
a cross-linkable polymer soluble in the base fluid;
a cross-linking agent; and
a nonionic ethylene oxide/propylene oxide (EO/PO) surfactant having a hydrocarbon chain in the range from C₁₀ to C₁₆.

2. The gel composition of claim 1, wherein the surfactant has in the range from 5-80 moles of EO and in the range from 3-60 moles of PO.

3. The gel composition of claim 1, wherein the surfactant has an EO/PO ratio in the range from 1:2 to 4:2.

4. The gel composition of claim 1, wherein the gel composition is a metallic crosslinked fracturing fluid.

5. The gel composition of claim 1, wherein the metallic component of the gel composition is a transition metal.

6. The gel composition of claim 1, wherein the hydrophilic-lipophilic balance of the surfactant is in the range from 11 to 14.

7. The gel composition of claim 1, wherein the surfactant is water soluble.

8. The gel composition of claim 1, wherein the nonionic surfactant is present in the gel composition in the range from 0.0170% to 0.1013% by weight.

9. A method of treating an opening in a subterranean formation, the method comprising:
providing a gel composition comprising a base fluid comprising a brine solution, a cross-linkable polymer soluble in the base fluid and a cross-linking agent;
adding a nonionic ethylene oxide/propylene oxide (EO/PO) surfactant to the gel composition, the surfactant having a hydrocarbon chain in the range from C₁₀ to C₁₆;
injecting the gel composition into the opening in the subterranean formation;
cross-linking the gel composition; and
increasing the size of the opening in the subterranean formation with the gel composition.

10. The method of claim 9, wherein the surfactant has in the range from 5-80 moles of EO and in the range from 3-60 moles of PO.

11. The method of claim 9, wherein the surfactant has an EO/PO ratio in the range from 1:2 to 4:2.

12. The method of claim 9, wherein the hydrophilic-lipophilic balance of the surfactant is in the range from 11 to 14.

13. The method of claim 9, wherein the surfactant is water soluble.

14. An uncrosslinked gel system or polymer or viscous fluid composition for use in a subterranean formation, the uncrosslinked gel system or polymer or viscous fluid composition comprising:
a base fluid comprising a brine solution;
a polymer or viscous fluid soluble in the base fluid; and
a nonionic ethylene oxide/propylene oxide (EO/PO) surfactant having a hydrocarbon chain in the range from C₁₀ to C₁₆.

15. The composition of claim 14, wherein the surfactant has in the range from 5-80 moles of EO and in the range from 3-60 moles of PO.

16. The composition of claim 14, wherein the surfactant has an EO/PO ratio in the range from 1:2 to 4:2.

17. The composition of claim 14, wherein the hydrophilic-lipophilic balance of the surfactant is in the range from 11 to 14.

18. The composition of claim 14, wherein the surfactant is water soluble.
